(19) United States
(12) Patent Application Publication
(10) Pub. No.: US 2003/0187732 A1
(43) Pub. Date: Oct. 2, 2003

(54) Method and system for presenting a sales incentive

(76) Inventor: Joseph D. Seta, Boca Raton, FL (US)

Correspondence Address: Squire, Sanders & Dempsey L.L.P., Two Renaissance Square, Suite 2700, 40 North Central Avenue, Phoenix, AZ, 85004-4498, US

(21) Appl. No.: 10/113,217

(22) Filed: Mar. 29, 2002

(51) Int. Cl. G06F 17/60

(52) U.S. Cl. 705/14

(57) ABSTRACT

A method for presenting a sales incentive is disclosed. Initially, a sales call is received from a client. After the sale to the client is completed, the client is offered the opportunity to play a sales incentive game such as answering a trivia question. If the client declines the offer the sales call is terminated. If the client chooses to listen to the question, the client receives a sales incentive, if the client provides the correct answer to the question. If the client provides an incorrect answer, no sales incentive is offered.

### TECHNICAL FIELD

This invention relates to a method and systems for selling goods and services over the telephone or over a computer network, and more particularly for a method and system for presenting a sales incentive.

### BACKGROUND OF THE INVENTION

Many goods and services are sold today via the telephone, mail, e-mail. catalogs or over a computer network such as the Internet. Often times, once a customer has purchased a good or service an upsell is offered to the customer. Typically, the upsell is a sales incentive such as an offer to purchase additional items at a discounted price. This is done both to reward loyal customers as well as to increase the sales of the marketer. These upsells are offered typically to every customer who makes an order and the customer is given a chance to either accept or turn down the thank you incentive. However, a large number of individuals fail to take advantage of upsells. One reason is that when the upsell is offered to every customer who places an order, the customers perceive the upsell or sales incentive as having little value. That is, the lack of any real contested value to the makes the incentive less valuable.

### SUMMARY OF INVENTION

Therefore, a need has arisen for a method and system for presenting an upsell or sales incentive that overcomes the disadvantages of the present system. In the current invention, an upsell or sales incentive is only offered if the customer wins a sales incentive game such as by giving a correct response to a trivia question. In this fashion, the upsell or sales incentive has a value over a typical upsell or sale incentive in that the customer feels that he or she has actually done something to win the upsell or sales incentive and therefore is less likely to turn down the upsell or sales incentive

In one embodiment, a method for presenting a sales incentive is disclosed. The method comprises a first step of receiving a sales call from a client. Then a sale to the client is completed and the client is offered the opportunity to participate in a sales incentive game. Next, the sales incentive game is played with the client. If the client is successful in the sales incentive game, the client is presented with the sales incentive.

In another embodiment, an apparatus for presenting a sales incentive is disclosed. The apparatus comprises a sales terminal that is operable to take orders for goods from a client. The sales terminal is further operable to present a sales incentive game to the client. Upon a successful result in the sales incentive game the client is offered the sales incentive.

In another embodiment, a method of communicating a sales incentive to a consumer is disclosed. First, an invitation to play a sales incentive game in order to receive the sales incentive is communicated to the consumer. Next, an acceptance from the consumer indicating the consumer wants to play the sales incentive game is received. Then, the sales incentive game is played. The sales incentive is offered to the consumer if the sales incentive game is successfully played.

In the above embodiments, the sales incentive game may be a game of knowledge such as a trivia game. Alternatively, the game may be a game of skill or chance. The sale incentive may be a discount off a future purchase, an offer of free shipping, a free item or any other valuable incentive.

Benefits of the present invention include providing a sales incentive that is more likely to be accepted. Also, the present invention allows for different levels of incentives based on answering more complex questions or winning multiple sale incentive games in a row. Additionally, the game aspect of the present invention may be introduced to the client at the time of sale or using various advertising means. The present invention is adaptable for use with live operators, interactive response units or for purchases over a computer network, such as the Internet. Other benefits are apparent from the following descriptions, illustrations and claims.

### BRIEF DESCRIPTION OF THE DRAWINGS

Non-limiting and non-exhaustive preferred embodiments of the present invention are described with references to the following figures wherein like reference numerals refer to like parts throughout the various views unless otherwise specified:

FIG. 1 is a block diagram of an exemplary embodiment of the present invention;

FIG. 2 is a block diagram of an embodiment of sales center;

FIG. 3 is a block diagram of an alternative embodiment of sales center;

FIG. 4 is a flow chart illustrating a method for presenting an upsell in accordance with the teachings of the present invention; and

FIG. 5 is a flow chart illustrating an alternative embodiment of a method for presenting an upsell in accordance with the teachings of the present invention.

### DETAILED DESCRIPTION OF THE PREFERRED EMBODIMENTS

The following descriptions of physical embodiments of the present invention are for exemplary purposes only. The sales incentive game can be used in any number of physical settings including, but not limited to, those described in the following figures. The term upsell and sales incentive can be used interchangeably.

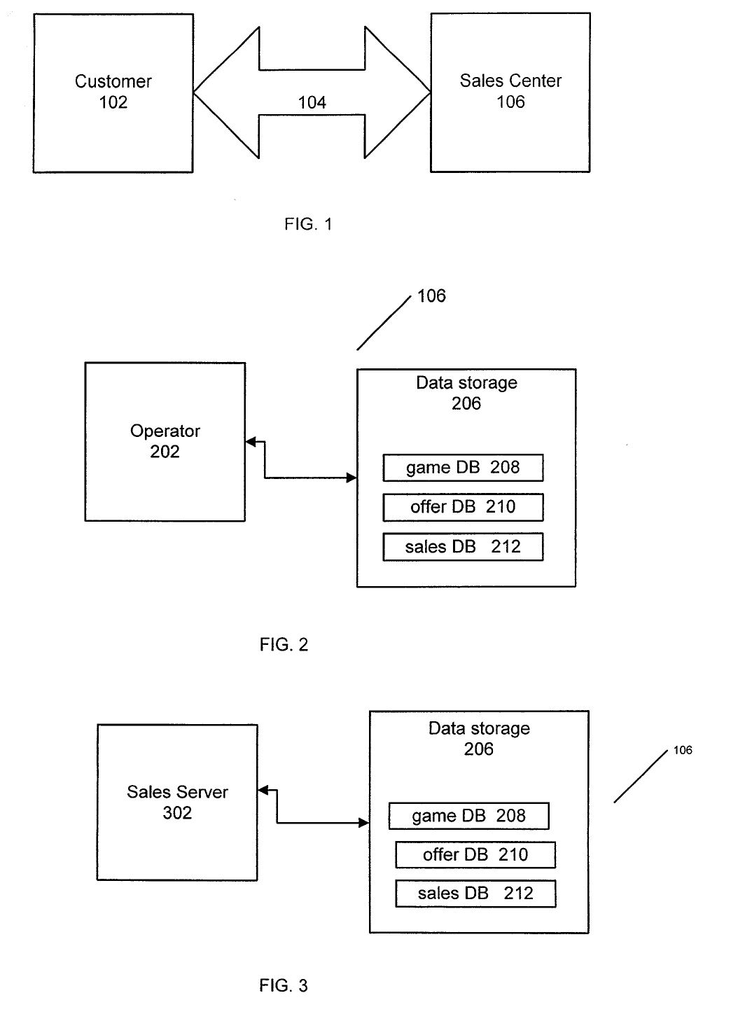

FIG. 1 is a block diagram of an exemplary embodiment of the present invention. Illustrated are a customer 102 and a sales center 106. Information is exchanged between customer 102 and sales center 106. For example, customer 102 may contact sales center 106 to make a purchase. Sales center 106 sends information back to customer 102 including sales confirmation and the offer to play a sales incentive game. A sales incentive game can be a game of knowledge such as a trivia game, a game of skill or a game involving random chance.

Customer 102 can be any individual wanting to purchase or inquire about purchasing any goods or services. For example, customer 102 can be an individual placing an order for an item by calling sales center 106. Customer 102 can be an individual purchasing an item listed in a catalog, at a website or shown on television over a computer network such as the Internet. Customer 102 can be an individual contacting sales center 106 to inquire about a purchase to be made over the telephone, a computer network, the Internet and the like. Additionally, customer 102 could contact sales center 106 based on an incentive or advertisement that is sent to customer 102 via the mail, electronic-mail, telemarketing calls or in response to an advertisement. For example, a customer 102 may receive a letter that includes a phone number to call or a web site to access in order to play a sales incentive game for a chance to win a sales incentive.

Sales center 106 is any facility designed to receive inquiries and requests from customer 102 and process the requests. Sales centers can be manually operated or automated. For example, sales center 106 can be a call center having a plurality of live operators able to receive and respond to inquires and requests from customers 102. Sales center 106 can also include an automated sales system such as one or more automated interactive voice response units (IRVUs) operable to receive and respond to inquiries and requests from customer 102. In another embodiment, sales center 106 can be one or more computers running a program operable to take orders for goods and services over a computer network.

Connection 104 can be a telephone connection between customer 102 and sales center 106, wired or wireless. It can also be any connection capable of connecting two computers such as the Internet, a local area network, a wide area network, a virtual private network and the like. The connection can be wired or wireless.

FIG. 2 is a block diagram of an embodiment of sales center 106. In this embodiment sales center 106 is a telephone sales center. Sales center 106 in this embodiment includes one or more operators 202 coupled to a database 206. Operator 202 can be a person receiving phone calls using a conventional telephone headset. In this embodiment the operator may have a computer or display terminal for inputting and displaying information such as sales information and information regarding the sales incentive game. Operator 202 may also be an automated system such as an interactive voice response unit (IRVU). An IRVU is a computerized system operable to receive calls from customer 102, take orders and interact with a customer.

Operator 202 preferably has access to a storage device 206. This access may be via a display terminal for a live operator or the storage device may be coupled to the IRVU. Storage device 206 may contain a sales incentive game database 208 (containing the questions or other information needed to implement the sales incentive game), an offer database 210 (contains the upsell or sales incentive offers) and a sales database 212 (containing information needed to complete a sale). In one embodiment all databases are combined in a single database

In operation, operator 202 receives a call from customer 102. In one embodiment the call is made by a client in order to place an order for goods and services. The operator 202 can complete the call using sales database 212. If the operator 202 is a human operator, sales database 212 can be used in conjunction with a display terminal. The display terminal can assist in order taking, displaying the sales incentive game information such as questions or random game screens and results and the discount offer (upsell or sales incentive), if applicable. Alternatively, questions or random games and discount offers (upsell or sales incentive) can be provided to a live operator without the use of a computer database or display terminal by providing print copies of game questions and information to the operators.

If operator 202 is an IRVU, then the IRVU will receive the call, take an order using the sales database 212, initiate a sales incentive game such as by asking a trivia question selected from the sales incentive game database 208, and, if the customer wins the sales incentive game, communicate the sales incentive using the offer database 210. The sales incentive or upsell can be an amount to be discounted off a future purchase, a percent off a future purchase, a giveaway such as a free item or free shopping or any other valued item or service.

FIG. 3 is a block diagram of another embodiment of sales center 106. In this embodiment sales center 106 is a networked computer sales center. Sales center 106 in this embodiment includes a sale server 302 coupled to storage device 206. Sale server 302 can be any well known computer having a processor and memory and running an electronic commerce application using an operating system such as UNIX, LINUX, WINDOWS OS, and the like. Sales server 302 is coupled to a computer network using a communication interface, which can be any data communication, wired or wireless, such as a dialup connection, DSL connection, a broadband network connection, a wireless connection, and the like. In this embodiment, customer 102 is using a client computer to communicate with sales server 302.

Sales server 302 is coupled to a storage device 206. Storage device 206 may contain a sales incentive game database 208 (for storing questions and information regarding the sales incentive game), an offer database 210 (contains the upsell offers or sales incentives) and a sales database 212 (containing information needed to complete a sale). While these databases are shown as separate databases, the functionality can be combined in a single database or split over several databases. Storage server 206 can be integrated with sales server 302 or located remote from sales serve 302.

In operation, customer 102, utilizing a computer, sends a sales request to sales server 302. In one embodiment the communication is made by a customer 102 in order to place an order for goods and services via a computer network such as the Internet. Using sales database 212, sales server 302 can take orders for goods and service. Then, sales server 302 sends a message to the customer 102 inquiring if the customer 102 wishes to play the sales incentive game. If the customer wants to participate, sales incentive game database 208 can be used to select a sales incentive game. The game is provided to the customer who can type in an answer or play the game. In the event customer 102 wins the sales incentive game, the offer database 210 can be used to select a sales incentive to present to the customer.

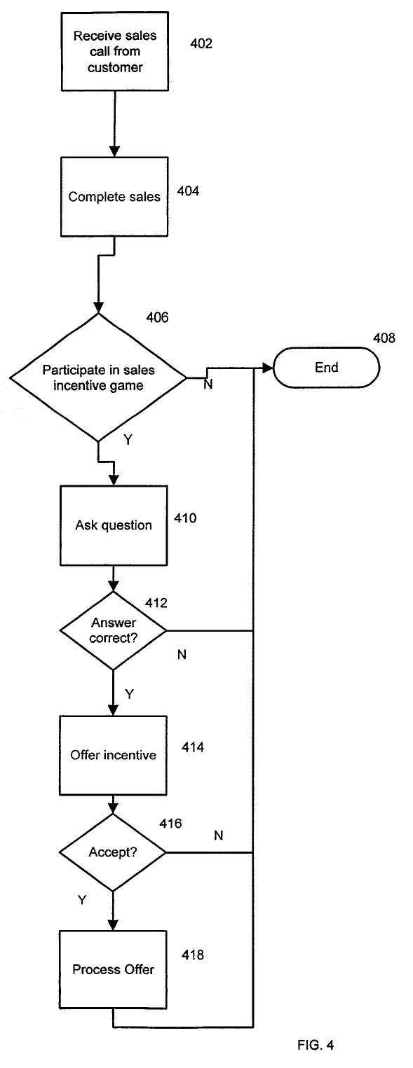

FIG. 4. is a flow chart illustrating a method for presenting the sales incentive in accordance with the teachings of the present invention. In step 402 a sales call is received by sales center 106. This sales call could be a telephone call made by a customer 102 to a sales center 106 or it could be a sales order received at sales center 106 by a computer network. In either case, the sales call is initiated by an individual wishing to purchase a goods or services offered by the operator of sales center 106. In step 404 that initial sales transaction is completed. That is, whatever items the customer 102 wished to purchase are purchased and any confirmation of the purchase is sent back to or given to customer 102.

In step 406 the customer is asked whether he or she wishes to participate in a sales incentive game. This request is either asked by a human operator, an IRVU, or the request is sent over computer network to customer 102 who would in that case be operating a computer or similar device to access sales center 106. If the customer declines to play the game, then in step 408 the process ends. If the customer 102 decides to continue then in step 410 the sales incentive game is initiated.

In one embodiment the sales incentive game is retrieved from a database. The sales incentive game can be a trivia game that tests knowledge in an area. The trivia question can be either a multiple choice question, a question that requires a simple statement answer or a true/false question as any other means of testing an individual's knowledge on the subject. Obviously, multiple-choice answers are easier to deploy for computerized systems such as a sales server or an IRVU unit. The question asked can be stored a sales incentive game database 208 as shown in FIGS. 2 and 3. Alternatively, the questions can be stored on a list or on a book or in any other convenient fashion that the operator can access. The questions can be chosen at random or the same questions can be given to each person who calls up. By tracking the client with the question asked, steps can also be taken to ensure that the same individual does not always receive the same question. In one embodiment, only one question needs to be answered before receiving an incentive. Alternatively a series of questions can be asked of which a certain number must be answered correctly in order to receive the sales incentive. Also, in another embodiment, the customer may be asked one question and then if answered correctly the customer can be asked if the customer wants to receive another question to receive a better incentive or to keep the incentive that the customer has just won. This process can go on for as many questions and as many incentives as desired by the operator of sales center 106. In another embodiment a choice is first given to the customer 102 as to what category of question the customer 102 wishes to have asked to him. In that case, once the customer 102 chooses a category such as sports, science, current events, history or the like, a question from that category is then generated and is then given to the customer 102. Or, the customer may select a degree of difficulty for a question, the more difficult the question the better the incentive.

In another embodiment, the sales incentive game may be a game of chance such as matching a customer's ID with a randomly generated numerical sequence, of guessing a randomly generated number, simulating or actually spinning a wheel having various results marked on the wheel, playing an instruction game or any other game of chance.

In another embodiment, the sales incentive may be a game of skill such as pressing a sequence of keys on a phone's keypad in a certain amount of time as any other game requiring skill more than luck or knowledge.

Regardless of the type of question asked or game played, in step 412 it is determined if the correct answer is given to the question or questions or if the customer 102 has won the game. If not, in step 408 the process ends. If the correct answer is given or the game is won, then in step 414 the sales incentive or upsell is offered. The sales incentive can be the purchase of additional goods or services at a discounted price. For example if the customer 102 gets the answer to the question correct the customer may be offered the chance to purchase a ring at a discounted price. The sales incentive may also be a percent off a future purchase in the form of a coupon or virtual coupon that the customer can redeem at some later point. The sales incentive may also be a credit to the customer's account or outright the gift of cash or free goods and services. The sales incentive could also be the transfer of a free goods and services to the customer. As discussed previously multiple questions can be asked and the more questions answered correctly the better the sales incentive can be. Also, more than one sales incentive can be offered at one time. The list of sales incentive opportunities can be stored in offer database 210 within data storage 206 or can be provided in printed form to the operator or communicated to the operator in some other fashion.

In step 416 the customer could either accept or decline the sales incentive. If the customer declines the sales incentive then in step 408 the process again ends. If the customer accepts the sales incentive, then that sales incentive is processed in step 418 and then the process will end in step 408.

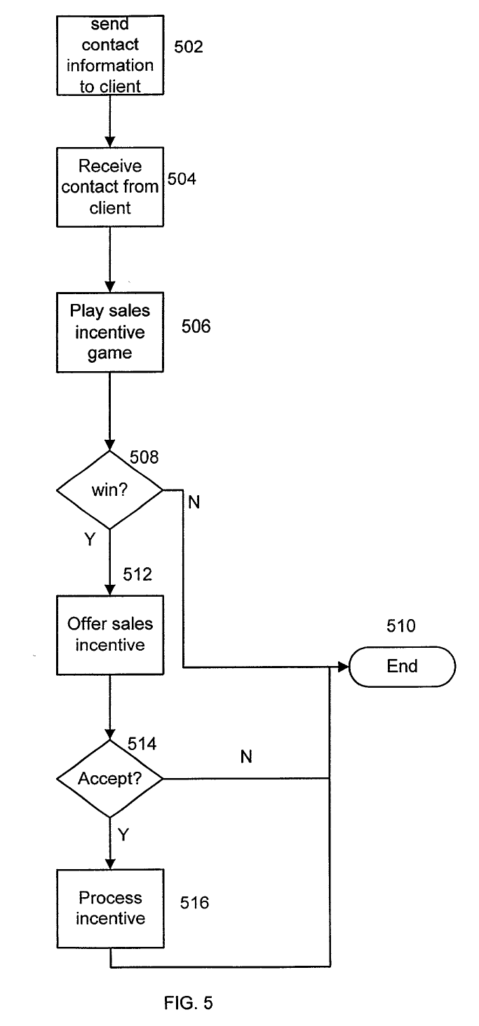

FIG. 5 is a flow chart illustrating an alternative embodiment of the present invention. In step 502 the operator of sales center 106 sends contact information to customer 102. This contact information can be an e-mail sent to the customer 102 indicating that the customer should call an operator or log onto a computer network and access the sales site of sales center 106 in order to play a sales incentive game for the chance to win or obtain the sales incentive or upsell, such as a discount on goods. Instead of an e-mail, regular mail can also be sent with that offer. Also the offer to contact sales center 106 can be made by an advertisement in a magazine, newspaper, on-line banner ad and the like. Also, the contact could be made by a phone call by a telemarketer, paged to an individual's paging unit or set as a message to a cellular phone using short messaging service (SMS). In step 504 sales center 106 is contacted by customer 102. As described previously this contact can be a phone call by customer 102 or it can be a contact over a computer network utilizing sales center 106. Once contact is made then the customer is asked a play a sales incentive game in step 506. As discussed previously this sales incentive game can be a game of knowledge such as a trivia question or a game of skill or a game of chance. Again the question or game can either be a single question or game presented to the customer 102 or can be multiple questions or games with an increased level of incentive for questions answered or games successfully played.

In step 508 it is determined if the customer 102 answered the question correctly or played the game successfully. If not, in step 510 the process ends. If so then the process continues as before in FIG. 4. That is in step 512 the sales incentive or upsell is offered to the customer. In step 514 it is determined if the customer accepts the sales incentive. If the customer does not accept the sales incentive, then in step 510 the process ends. If the customer accepts the sales incentive then in step 516 the sales incentive is processed and the process then ends in step 510.

Having now described preferred embodiments of the invention, modifications and variations to the present invention may be made by those skilled in the art. The invention is thus not limited to the preferred embodiments, but is instead set forth in the following clauses and legal equivalents thereof.

What is claimed:

1. A method for presenting a sales incentive comprising:
receiving a sales call from a client;
completing a sale to the client and offering the opportunity to participate in a sales incenitve game;
playing the sales incentive game; and
presenting the sales incentive to the client if the client is successful in the sales incentive game.

2. The method of claim 1 wherein the step of playing the sales incentive game further comprises asking the client a trivia question.

3. The method of claim 2 wherein the step of asking the client a trivia question further comprises allowing the client to chose a subject category from which the trivia question will be selected.

4. The method of claim 2 wherein the step of asking the client a trivia question further comprises allowing the client to choose the difficulty level of the trivia question and wherein the difficulty level of the question is associated with the value of the sales incentive.

5. The method of claim 2 wherein the step of asking the client a trivia question further comprises asking a series of trivia questions and rewarding the client based on the number of correct answers, the number of correct responses determining the value of the sales incentives.

6. The method of claim 2 wherein the step of asking the client a trivia question further comprises asking a series of questions allowing the client to chose, after each correct answer to a question to stop and receive a current sales incentive or to continue to answer questions, the value of the sales incentive associated with the number of questions answered.

7. The method of claim 1 wherein the sales incentive is the opportunity to buy an item at a reduced price.

8. The method of claim 1 wherein the sales incentive is a percent discount off a future purchase.

9. The method of claim 1 wherein the step of playing the sales incentive game further comprises paying a game of chance.

10. The method of claim 1 wherein the step of playing the sales incentive game further comprises playing a game of skill.

11. An apparatus for presenting a sales incentive comprising a sales terminal operable to take orders from a client, the terminal further operable to present a sales incentive game to the client and upon a successful result in the sales incentive game offer the sales incentive.

12. The apparatus of claim 11 wherein the sales incentive game is a trivia game in which the client is asked a trivia question.

13. The apparatus of claim 11 wherein the sales terminal is a live operator.

14. The apparatus of claim 11 wherein the sales terminal is an interactive voice response unit.

15. The apparatus of claim 11 wherein the sales terminal is a computer operable to take orders for goods from a client computer coupled to the computer via a computer network.

16. The apparatus of claim 12 wherein the client chooses a subject category from which the trivia question will be selected.

17. The apparatus of claim 12 wherein further client chooses the difficulty level of the trivia question and the difficulty level of the question is associated with the value of the sales incentive.

18. The apparatus of claim 12 wherein a series of trivia questions are asked and the number of correct responses determines the value of the sales incentives.

19. The apparatus of claim 12 wherein the client chooses, after each correct answer, to either stop and receive a current sales incentive or to continue to answer questions to obtain a better sales incentive.

20. The apparatus of claim 11 wherein the sales incentive is the opportunity to buy an item at a reduced price.

21. The apparatus of claim 11 wherein the sales incentive is a percent discount off a future purchase.

22. The apparatus of claim 11 wherein the sales incentive game is a game of skill.

23. The apparatus of claim 11 wherein the sales incentive game is a game of chance.

24. A method of communicating a sales incentive to a consumer comprising:
communicating to the consumer an invitation to play a sales incentive game in order to receive the sales incentive;
receiving an acceptance from the consumer indicating the consumer wants to play the sales incentive game;
playing the sales incentive game; and
offering the sales incentive if the sales incentive game is successfully played by the consumer.

25. The method of claim 24 wherein the step of playing the sales incentive game comprises asking a trivia question.

26. The method of claim 24 wherein the step of communicating to the consumer comprises sending an offer to the consumer to play a sales incentive game via electronic mail.

27. The method of claim 24 wherein the step of communicating comprises sending an offer to the consumer to play a sales incentive game via mail.

28. The method of claim 24 wherein the step of communicating comprises communicating to the consumer an invitation using an advertisement.

29. The method of claim 24 wherein the step of communicating comprises asking the consumer to play a sales incentive game after the consumer has purchased goods or services.

30. The method of claim 25 where the step of asking a trivia questions further comprises allowing the consumer to chose a subject category from which the trivia question will be selected.

31. The method of claim 25 wherein the step of asking a trivia question further comprises allowing the consumer to choose the difficulty level of the trivia question and wherein the difficulty level of the question is associated with the value of the sales incentive.

32. The method of claim 25 wherein the step of asking a trivia question further comprises asking a series of trivia questions and rewarding the consumer based on the number of correct answers, the number of correct responses determining the value of the sales incentives.

33. The method of claim 25 wherein the step of asking a trivia questions further comprises asking a series of questions allowing the consumer to chose, after each correct answer to a question to stop and receive a current sales incentive or to continue to answer questions, the value of the sales incentive associated with the number of questions answered.

34. The method of claim 24 wherein the sales incentive is the opportunity to buy an item at a reduced price.

35. The method of claim 24 wherein the sales incentive is a percent discount off a future purchase.

36. A sales incentive presentation apparatus comprising a means for playing a sales incentive game with a consumer and a means for presenting a sales incentive to the client if the client wins the sales incentive game.

37. The apparatus of claim 36 wherein the sales incentive game is a trivia game in which the client is asked a trivia question.

38. The apparatus of claim 37 wherein the client chooses a subject category from which the trivia question will be selected.

39. The apparatus of claim 37 wherein the client chooses the difficulty level of the trivia question and the difficulty level of the question is associated with the value of the sales incentive.

40. The apparatus of claim 37 wherein a series of trivia questions are asked and the number of correct responses determines the value of the sales incentives.

41. The apparatus of claim 37 wherein the client chooses, after each correct answer, to either stop and receive a current sales incentive or to continue to answer questions to obtain a better sales incentive.

42. The apparatus of claim 36 wherein the sales incentive is the opportunity to buy an item at a reduced price.

43. The apparatus of claim 36 wherein the sales incentive is a percent discount off a future purchase.

44. The apparatus of claim 36 wherein the sales incentive game is a game of skill.

45. The apparatus of claim 36 wherein the sales incentive game is a game of chance.

46. A medium storing instructions adapted to be executed by a processor to perform a method for communicating a sales incentive to a consumer comprising:
playing a sales incentive game with a consumer; and
offering the sales incentive to the consumer if the consumer wins the sales incentive game.
